(19) United States
(12) Patent Application Publication
(10) Pub. No.: US 2022/0230256 A1
(43) Pub. Date: Jul. 21, 2022

(54) SYSTEM AND METHOD FOR LEDGER ANALYTICS AND APPLICATION OF DIGITAL TAX STAMPS

(71) Applicant: Fawad Zafar, London (GB)

(72) Inventor: Fawad Zafar, London (GB)

(21) Appl. No.: 17/616,652

(22) PCT Filed: May 29, 2020
(86) PCT No.: PCT/EP2020/065005

§ 371 Date: Dec. 4, 2021

Related U.S. Application Data
(60) Provisional application No. 62/857,695, filed on Jun. 5, 2019.

(51) Int. Cl. G06Q 40/00; H04L 9/08; G06Q 20/20; G06Q 30/02; G06Q 10/10

(52) U.S. Cl. CPC G06Q 40/123; H04L 9/0825; G06Q 10/109; G06Q 30/0201; G06Q 20/207

(57) ABSTRACT

Systems, methods, and computer program media are provided for the analysis of ledger entries relating to the transfer of assets, potentially among disparate jurisdictions, for real-time accounting for tax liabilities resulting from such transfers, and for the display of analysis results. Digital tax stamps are used to provide verification of the payment of taxes.

### TECHNICAL FIELD

The present invention relates to the analysis of ledger entries and displaying the results of such analysis. In particular, the invention relates to systems, methods, and computer program media for the analysis of ledger entries relating to the transfer and hedge of assets, potentially among disparate jurisdictions, real-time accounting for tax liabilities resulting from such transfers, and displaying the results of such analysis.

### BACKGROUND

The transfer of funds and assets among entities, both individuals and corporate entities, often results in effective value gains and losses on behalf of the transferring entities. Such value gains and losses generally must be considered for the entities' internal accounting practices and often have implications for the entities' tax liabilities. These gains and losses can be based on the changes in value assets can exhibit over time or based on an asset with a given market value being exchanged for a higher or lower price than the market value. Hedge accounting and transfer pricing among two corporate entities that are under common control is a special case of this phenomenon, for example, where subsidiary corporate entities of a corporate parent transact with one another. For example, Subsidiary A could sell a widget to Subsidiary B at “Price X.” But if Subsidiary B could otherwise obtain this widget at “Price X-Y,” a profit of Y would effectively be shifted from Subsidiary B to Subsidiary A. By this mechanism, known as “transfer mispricing,” profit can be shifted between the subsidiary entities, potentially in a manner that allows the corporate entities to shift profits to entities subject to low taxation jurisdictions and thereby avoid paying a portion of what would otherwise be the corporate family's net tax liability. Accordingly, there exist complex regimes of tax regulations to generally enforce an arm's length transaction rule wherein related entities must establish pricing between them that are equivalent to prices between two unrelated entities. And where such prices between related entities are not equivalent, the corporate entities incur tax liabilities to account for the value transfer. This regime establishes that related entities incur a tax liability when there are even slight departures from arm's-length transactions. Related entities are required to maintain extensive records to prove their compliance with transfer pricing regulations and to remit taxes periodically, incurring substantial accounting and auditing costs.

In many countries, VAT expenses incurred in the country are refundable to individuals who are visitors or tourists upon their exit from the country. However, the current system requires such individuals to maintain detailed records and often results in over-taxation of them.

Accordingly, there is a need to streamline tax compliance for transactions that incur tax liabilities in a transparent, verifiable, and automatic manner where taxes are remitted to a taxing authority.

### SUMMARY OF THE INVENTION

To address the above-describe situations, and other aims, a system and method for analyzing ledger entries and applying tax stamps has been developed wherein tax liability is determined and funds are remitted to tax authorities in an automatic, verifiable, auditable, and streamlined manner.

One aspect of the present invention is a computer-implemented method for analyzing ledger entries, comprising: receiving with a processor transaction data comprising data reflecting the transfer of an asset from a first entity to a second entity in exchange for a payment from the second entity, the asset represented in a balance ledger associated with the first entity and receiving with a processor entity description data associated with the first entity and with the second entity. The method further includes determining with a processor a tax authority to which tax is due from the first entity as a result of the transaction based at least in part on the transaction data and the entity description data. Then the method entails determining with a processor the tax liability incurred by the first entity as a result of the transaction based at least in part on the transaction data, the entity description data, and the tax authority. Additionally, the method includes transferring funds based on the tax liability to a tax liability account associated with the first entity and generating a digital tax stamp representing the tax liability of the first entity to evidence that funds have been transferred to a tax liability account associated with the first entity.

In certain embodiments, the method may further include generating tax liability documentation based at least in part on the digital tax stamp and sending funds from the tax liability account to the tax authority based on at least in part the digital tax stamp.

In certain embodiments, the method may further include determining with a processor a change in asset value based at least in part on the asset market value data, wherein the transaction data includes asset market value data comprising historical asset market value data corresponding to when the first entity acquired the asset and current asset market value data corresponding to when the transaction occurred, wherein the generation of the tax liability is further based on the change in asset market value.

In certain embodiments, the input/output ledger and/or balance ledger can be shared with a third entity.

In certain embodiments, the method can further include providing a state space representation in the form of a financial calendar interface, the financial calendar interface having a rectangular grid structure wherein each subsection of the grid corresponds to a given unit of time. In the financial calendar interface, presenting a balance ledger metric, an input metric, and an output metric, each corresponding to the given unit of time in each rectangular subsection of the grid corresponding to that respective unit of time.

In another aspect of the present invention, computer-implemented method for analyzing ledger entries is provided, comprising: receiving with a processor transaction data comprising data reflecting the transfer of an asset from a first entity to a second entity in exchange for a payment from the second entity, the asset represented in a balance ledger associated with the first entity and receiving with a processor entity description data associated with the first entity and with the second entity. The method further includes determining with a processor a tax authority to which tax is due from the first entity as a result of the transaction based at least in part on the transaction data and the entity description data. Then the method entails determining with a processor the tax liability incurred by the first entity as a result of the transaction based at least in part on the transaction data, the entity description data, and the tax authority. Additionally, the method includes transferring funds based on the tax liability to the tax authority; and receiving from the tax authority a digital tax stamp to evidence that the tax liability has been paid.

In yet another aspect of the present invention, a system is provided comprising a processor capable of executing computer files and a memory. The memory comprises processor-executable computer files for performing the steps of: receiving with a processor transaction data comprising data reflecting the transfer of an asset from a first entity to a second entity in exchange for a payment from the second entity, the asset represented in a balance ledger associated with the first entity and receiving with a processor entity description data associated with the first entity and with the second entity. The method further includes determining with a processor a tax authority to which tax is due from the first entity as a result of the transaction based at least in part on the transaction data and the entity description data. Then the method entails determining with a processor the tax liability incurred by the first entity as a result of the transaction based at least in part on the transaction data, the entity description data, and the tax authority. Additionally, the method includes transferring funds based on the tax liability to the tax authority and generating a digital tax stamp representing the tax liability of the first entity to evidence that funds have been transferred to the tax authority to account for the tax owed by the first entity.

### BRIEF DESCRIPTION OF THE DRAWINGS

Various embodiments in accordance with the present disclosure will be described with reference to the drawings, in which:

FIG. 1 illustrates a transaction between two entities wherein the present invention may be utilized.

FIG. 2 illustrates an example process for analyzing ledger transactions and applying digital tax stamps.

FIG. 3 illustrates an example of displaying analysis data.

FIG. 4 illustrates example components of a computing device that can be utilized in accordance with various embodiments.

FIG. 5 illustrates an example environment in which aspects of the various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods in accordance with various embodiments of the present disclosure may overcome one or more of the aforementioned and other deficiencies experienced in conventional approaches to tax remittance.

Various other functions and advantages are described and suggested below as may be provided in accordance with the various embodiments.

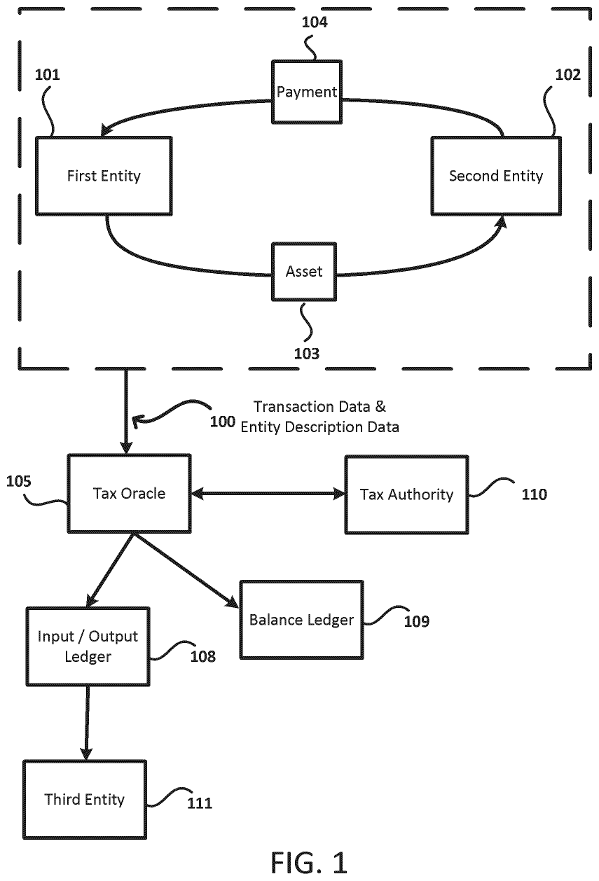

FIG. 1 illustrates a transaction between two entities 101, 102 wherein the invention may be utilized. A first entity 101 sends an asset 103 to a second entity 102 in exchange for a payment or other transfer of value 104. The entities may be individuals, partnerships, corporations, or any other type of entity that is legally able to own property and transact with others. The asset 103 may be a tangible object, fiat currency, another form of money, a digital asset such as a digital file, a digital representation of real estate or a tangible or intangible object, blockchain token, digital currency, virtual currency, data, intellectual property, or any other asset, item of property or the like. The payment 104 may be anything having value or having no value, including fiat currency or another type of asset. In some cases, the payment 104 may have no value or be nothing, such that the transaction is gratuitous and wherein the first entity 101 provides the asset 103 to the second entity 102 at no cost.

The asset 103 had a historical market value at the time it was acquired by the first entity 101, and had a current market value at the time it is sent to the second entity 102 that may be different from the historical market value. Likewise, the payment 104 had a historical market value at the time it was acquired by the second entity 102, and had a current market value at the time it was sent to the first entity 101 that may be different from the historical market value. The historical market value of the asset 103 may be incorporated into a balance ledger 109 associated with the first entity 101 prior to the transaction. The balance ledger may be any sort of electronic data structure capable of storing information, such as a type of database—such as a SQL, object-oriented, NoSQL, NewSQL, QLDB, time-series databases, or XIVIL database—, a spreadsheet, a blockchain, a tangle, a smart contract, or another type of data structure. And after the transaction, the balance ledger may reflect the first entity's loss of the asset 103 and gain of the payment 104. Likewise, the historical market value of the payment 104 may be incorporated into a second balance ledger associated with the second entity 102 prior to the transaction. And after the transaction, the balance ledger 109 may reflect the second entity's loss of the payment 104 and gain of the asset 103.

The first entity 101 may also be located in a different location than the second entity 102, such that it may be subject to a different legal regime including tax and transfer pricing regulations. A jurisdiction is a region in which particular laws, rules and regulations for the remittance of taxes in connection with transactions apply with respect to a particular or multiple tax authorities. Jurisdictions may be nations, states, provinces, cities, counties, and the like, or geographically located or virtual, or wherein an entity may choose to be subject to a particular legal regime via virtual citizenship, registration, virtual location, or another method. When the first entity 101 is in a separate physical or virtual location from the second entity 102, such that different legal rules apply between the two entities, the jurisdiction of the first entity 101 is typically considered the source jurisdiction and the jurisdiction of the second entity 102 is typically considered the destination jurisdiction. Each jurisdiction may have its own respective, or multiple, tax authorities. The first entity 101 may incur a tax liability to the tax authority 110 of the source jurisdiction, the destination jurisdiction, and other jurisdictions that exercise taxing power over the first entity 101. The tax authority may be a governmental entity or any other entity with the authority or power to impose or collect tax, fees, and the like.

In accordance with a preferred embodiment of the invention, transaction data and entity description data 100 is received by a tax oracle 105. Transaction data may reflect the sending of the asset from the first entity 101 to the second entity 102 as well as the sending of the payment from the second entity to the first entity 101. In certain embodiments, only the sending of the asset or the sending of the payment may be reflected. The transaction data may include information relevant to the tax liabilities of the entities with respect to the transaction, such as the historical and current market values of the asset and the payment, as well as relevant details regarding the character of the asset and payment, such as whether the asset is a particular product subject to general and/or specific tax requirements, e.g., alcohol, tobacco, cannabis, and the like. The transaction data may also include locations of the asset and the payment, as well as source and destination locations of each, as well as the time each is sent from one entity to the other. Entity description data contains information about the first entity relevant to the taxation of at least the first entity with respect to the transaction, but may also include information regarding the second entity relevant to its taxation with respect to the transaction. Such entity description data may include the physical or virtual location of the entity, information regarding the character of the entity, such as individual or corporate form (e.g., corporation, partnership, non-profit corporation, LLP, LLC, etc.), jurisdiction of incorporation, primary place of business, as well as other relevant information. The entity description data may contain information about each entity or optionally, only the first entity or only the second entity.

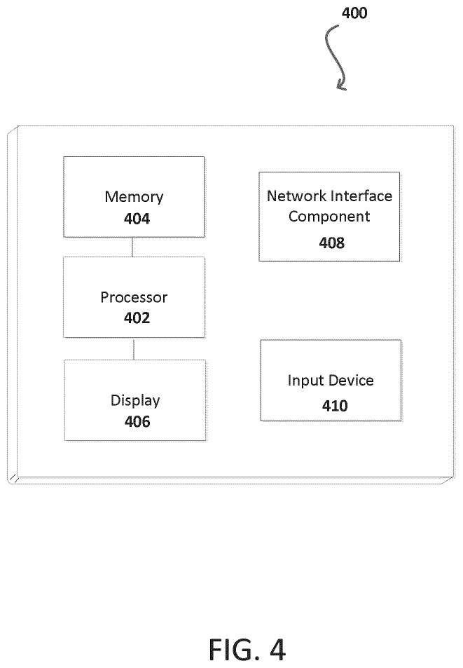

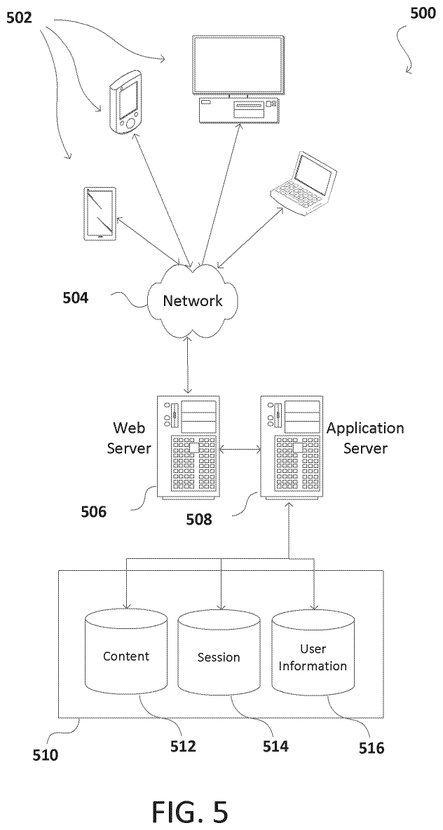

The tax oracle 105 receives the transaction data and entity description data 100 and uses these data to determine and apply the tax liability for at least the first entity 101 with respect to at least one tax authority 110. The tax oracle may be a system containing, potentially among other things, the computing device or devices described below in relation to FIGS. 4 and 5 to accomplish the claimed method and implement the claimed system. The tax oracle may also include equipment, such as those described in relation to FIGS. 4 and 5, for electronic financial accounts containing funds on behalf of entities, such as the transacting first and second entities, from which funds may be allocated for payment of a tax liability and sent to a tax authority 110 for the payment of a tax. The tax oracle may alternatively or additionally be connected, such as with a network via equipment such as those described in relation to FIGS. 4 and 5, to a financial institution holding funds of entities, such as the transacting first and second entities, from which funds may be allocated or withdrawn for payment of a tax liability and sent to a tax authority 110. The tax authority 110 can be the source jurisdiction tax authority, the destination jurisdiction tax authority, or another jurisdiction tax authority with an interest in the transaction. In some embodiments, once the tax liability has been determined, the tax oracle 105 allocates funds to satisfy the tax payment into a tax liability account for later remittance to the tax authority 110. The tax liability account may be an escrow account that requires the consent of both the tax oracle and the first entity to withdraw funds therefrom. In other embodiments, the tax oracle 105, upon determination of the tax liability, send funds to satisfy the tax payment directly to a respective tax authority, such as the tax authority 110. Payment to the tax authority 110 can occur immediately with the transaction or after a certain period of time from the tax liability account to which funds were previously allocated.

The tax oracle 105 may further generate a digital tax stamp evidencing the allocation of funds to pay the tax liability to the tax liability account for future transfer to the relevant tax authority 110. Alternatively, the tax oracle 105 may generate a digital tax stamp upon payment of funds to satisfy the tax liability to the tax authority 110. And in an alternative embodiment, the tax authority 110 may itself generate or provide to the tax oracle 105 a digital tax stamp certifying its acceptance of the payment of funds to account for the tax liability.

A digital tax stamp is preferably a collection of data containing the tax liability incurred as a result of the transaction. A digital tax stamp may alternatively be a digital representation of tax paid. The tax stamp may include the profit or loss incurred by an entity to the transaction. It can reflect the tax obligations associated with the particular transaction and is preferably suitable for presentation to prove tax compliance (e.g., proof of the time and amount of a tax payment) as to the particular transaction. The digital tax stamp may further include tax identification information of the entity for which the tax is being accounted for or paid, such as a taxpayer identification number issued by a tax authority, another identification, a cryptographic signature or key corresponding with the entity, or another type of such information. The digital tax stamp may include a digital signature incorporating one or more private keys under the control of the tax oracle 105, the first entity, or the tax oracle 105 and the first entity jointly. Alternatively, the digital tax stamp may include a digital signature of private keys under control of the tax authority 110. The digital tax stamp may be compliant with ISO 22382, a standard from the International Standards Organization pertaining to tax stamps.

Upon generating the digital tax stamp, the tax oracle may send it to the balance ledger 109 to update it to account for the payment or allocation of taxes. The tax oracle may further send the digital tax stamp to an input/output ledger 108 that may reflect the inputs (e.g., positive financial value resulting from the receipt of the payment 104) and outputs (e.g., negative financial value resulting from the sending of the asset 103) resulting from the transaction. In some embodiments, the input/output ledger 108 may be a single ledger. Alternatively, it may be two separate ledgers, i.e., an input ledger and an output ledger. The input/output ledger or input and output ledgers may be any sort of electronic data structures capable of storing information, such as a type of database—such as a SQL, object-oriented, NoSQL, NewSQL, QLDB, time-series databases, or XIVIL database—, a spreadsheet, a blockchain, a tangle, a smart contract, or another type of data structure. The input/output ledger 108 may be shared with a third entity 111, such as a third party accountants, auditors, creditors, lawyers, notaries, credit rating agencies, the taxing authority itself, or other entities to ensure compliance and the absence of unforeseen tax liabilities. The sharing with a third entity 111 may be accomplished via a ring network, mesh network, hub-and-spoke, or another network sharing method.

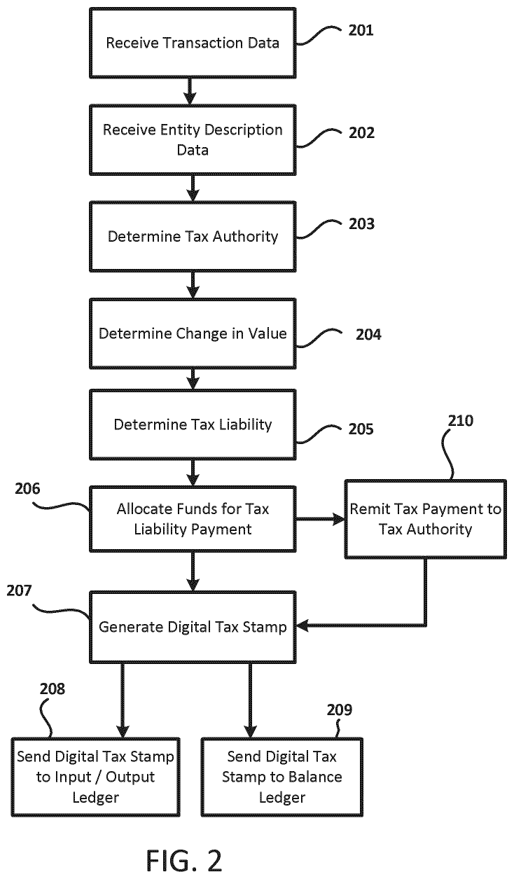

FIG. 2 illustrates an example process for analyzing the transaction described in FIG. 1 and generating a digital tax stamp. The process may be performed by the tax oracle 105. First, initial transaction data containing data reflecting a transaction of an asset 103 and payment 104 between a first entity 101 and a second entity 102 is received 201 by a processor in the tax oracle 105. The initial transaction data could contain a blockchain transaction or another data set indicating the occurrence of the specific transaction between the two entities 101, 102. The result of this transaction, the transfer of the asset 103 in exchange for a payment 104, may also be reflected in a balance ledger 108 corresponding to the first entity 101. Additional balance ledgers may exist that correspond to additional entities to the transaction.

Transaction data and entity description data associated with the first entity 101 and the second entity 102, which may itself be present in the transaction data or received from another source, may be received 202 by a processor in the tax oracle 105 and utilized to determine an applicable tax authority 203 to which tax is owed as a result of the transaction. Multiple tax authorities may be owed taxes as a result of the transaction, such as a state or federal government concurrently. Entity description data may contain the physical location of an entity, its principal place of business, jurisdiction of incorporation, citizenship, virtual citizenship, the shipment and delivery locations for the asset, and/or potentially other relevant information. The tax authority 110 may depend on these data, as well as other data contained in the entity description data received by the tax oracle 105 to determine tax liabilities.

The historical asset market value and the current asset value are then utilized to determine the change in asset value 204, if any. Asset market value information may come from public or private markets, from historical actuarial data, or another reliable source that the tax authority would accept as a source for price information. If change in asset value is de minimis or not relevant to the determination of tax liability (e.g., if there is no taxation on the accrued value of the asset), step 204 may be omitted.

Based on the transaction data, the entity description data, and the applicable tax authority 110, the tax liability resulting from the transaction may be determined by tax oracle 105. Tax lability may particularly vary based on the asset 103 involved in the transaction or the transfer. In certain embodiments, tax liability may be based on tax rates for capital or asset appreciations and decreases in value, for income, for sales (i.e., sales taxes or VAT taxes), for transfer prices that are not equivalent to arm's length transactions, and for particular items being transacted, such as excise taxes on regulated goods. Such regulated goods may be any taxable item, such as alcohol, tobacco, cannabis, gasoline, identified in a separate database, in the transaction data, or received from a separate source.

Funds for the payment of the tax liability previously determined 205 are then allocated to a tax liability account 206, and a digital tax stamp may be generated 207 by the tax oracle 105 to evidence the allocation of funds to satisfy the tax liability 206. The funds may come from a financial institution associated with the first entity, from an account held by the tax oracle, from the first entity directly, or from another source providing funds or credit to or on behalf of the first entity. The digital tax stamp may contain a digital signature of private keys under the control of the tax oracle 105, by public-private key cryptography. In certain embodiments, funds for the payment of tax liability determined 205 may be sent directly to a tax authority 210, and the digital tax stamp generated 207 by the tax oracle to evidence this payment. In other embodiments, the digital tax stamp may be generated by the tax authority 110 itself and may include a digital signature of private keys under control of the tax authority 110. When the digital tax stamp is generated 207 by the tax authority 110, it may optionally further be signed by private keys under control of the tax oracle 105.

The digital tax stamp may be transmitted to an input/output ledger 108 associated with entity liable for taxes resulting from the transaction 208, such as the first entity. The input/output ledger 108 allows verification that tax liabilities have been satisfied and taxes properly remitted based on the determined tax liability 205. This input/output ledger may be open to inspection by third party accountants, auditors, creditors, lawyers, notaries, credit rating agencies, the taxing authority itself, or other entities to ensure compliance and the absence of unforeseen tax liabilities.

The digital tax stamp may be additionally transmitted to the balance ledger 109 associated with one of the parties to the transaction 209, such as the first entity, to additionally reflect the tax implications of the transaction. The balance ledger 109 may then be updated to account for the entire impact of the transaction: both the payment for the asset 103 as well as the tax associated with the transaction.

Once the digital tax stamp is generated, it may further be relied on to remit taxes from the tax liability account 210 to the proper taxing authorities. Remittance of taxes 210 may occur immediately upon allocation 206 or after a period of time, such as every day, week, month, or a certain period of time after the transaction occurs. At any time, the tax oracle 105 may generate a tax form and withdraw from the tax liability account to remit tax payment to the tax authority 210. Because the balance ledger 109 has already accounted for this tax liability and payment 209, the process may be automatically performed and funds sent directly to the taxing authority shortly after the transaction occurs. Thereby, taxes due may be effectively withheld as the transaction is occurring and overhead costs associated with managing ongoing tax liabilities eliminated. If the taxing authority accepts automatic per-transaction payment, funds may be sent directly to the taxing authority rather than to a tax liability account.

The foregoing steps may be performed in any reasonable order, as would be apparent by a person having ordinary skill in the art.

The systems and methods of the invention may be applied in a variety of industries and scenarios. For example, they allow for the immediate and verifiable remittance of taxes to ensure compliance with transfer pricing regulations. Remittance of taxes to authorities on regulated materials like alcohol, tobacco, cannabis, and gasoline may also be streamlined by the systems and methods of the invention, wherein taxes can be paid at the time of the transaction, and accounting and compliance costs for the seller can be minimized. Likewise, capital gains and losses can be adequately accounted for in situations where the cost of doing so by traditional accounting and recordation means would be excessive. For example, two entities entering into a barter exchange may be a taxable event in some jurisdictions. However, recordation of such a transaction and verification that one's tax liabilities have been satisfied is often too difficult for the parties to the transaction to remit taxes to the proper taxing authority. Ease of tax payment encourages tax compliance, maximizes revenue, and thereby minimizes the inefficiency of unpaid taxes.

The systems and methods of the invention may additionally be usable to account for VAT payment throughout an economy, whereby taxes are remitted as transactions occur and delay between transactions and payment of taxes is minimized. Further, VAT payment can be automatically refunded or exempted for where inapplicable, for example to tourists or other exempt individuals purchasing items in a foreign country upon their exit of the country.

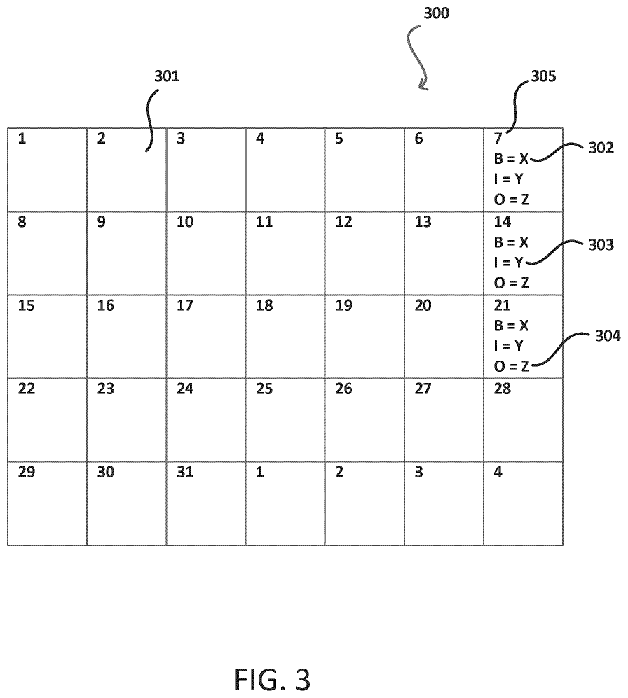

FIG. 3 depicts a financial calendar 300 displaying data produced by embodiments of the systems and methods of the invention. The financial calendar depicted in FIG. 3 displays financial and accounting information for one of the entities involved in a transaction. In alternative embodiments, information associated with additional entities can be displayed. The financial calendar 300 may be divided into rectangular boxes representing the days of a month 301. Each day 301 depicts the date 305, a metric depicting the balance value 302, a metric depicting input value 303, and a metric depicting output value 304. The balance value metric, denoted by B, 302 for a particular day displays the value of the balance ledger for that day. For days beyond the current date, the balance value metric may be a prediction of the expected balance value on that date, based on currently pending or expected transactions, optionally including regularly scheduled transactions. The balance value metric may optionally be based on the time at the start of that day or the end of a given day or the start of the given day. The input value metric, denoted by I, 303 for a particular day displays the inputs received during that day. For days beyond the current date, the input value metric may be a prediction of the expected balance value on that date, based on currently pending or expected transactions, optionally including regularly scheduled transactions. The output value metric, denoted by 0, 304 for a particular day displays the outputs output during that day. For days beyond the current date, the output value metric may be a prediction of the expected balance value on that date, based on currently pending or expected transactions, optionally including regularly scheduled transactions. Embodiments utilizing a financial calendar may depict the data in a monthly, weekly, daily, annual, quarterly, or other form. Additionally, any of the balance ledger, input ledger, and output ledger metrics may optionally be omitted, potentially by a user selection of a filter to only display one or more of such metrics.

FIG. 4 illustrates a logical arrangement of a set of general components of an example computing device 400 that can be used to implement aspects of the various embodiments. In this example, the device includes a processor 402 for executing instructions that can be stored in a memory device or element 404. As would be apparent to one of ordinary skill in the art, the device can include many types of memory, data storage, or non-transitory computer-readable storage media, such as a first data storage for program instructions for execution by the processor 402, a separate storage for images or data, a removable memory for sharing information with other devices, etc. The device typically will include some type of display element 406, such as a touch screen or liquid crystal display (LCD), although devices such as portable media players might convey information via other means, such as through audio speakers. As discussed, the device in many embodiments will include at least one input element 410 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 400 of FIG. 4 can include one or more network interface components 408 for communicating over various networks, such as a Wi-Fi, Bluetooth, RF, wired, or wireless communication systems. The device in many embodiments can communicate with a network, such as the Internet, and may be able to communicate with other such devices.

As discussed, different approaches can be implemented in various environments in accordance with the described embodiments. For example, FIG. 5 illustrates an example of an environment 500 for implementing aspects in accordance with various embodiments, such as to obtain content to be rendered by a 3D or VR headset, or other such device or display. As will be appreciated, although a Web-based environment is used for purposes of explanation, different environments may be used, as appropriate, to implement various embodiments. The system includes an electronic client device 502, which can include any appropriate device operable to send and receive requests, messages or information over an appropriate network 504 and convey information back to a user of the device. This can include, for example, image information captured for the face of a user or a request for virtual reality content to be rendered on a virtual reality headset or other such device. Examples of client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 506 for receiving requests and serving content in response thereto, although for other networks an alternative device serving a similar purpose could be used, as would be apparent to one of ordinary skill in the art.

The illustrative environment includes at least one application server 508 and a data store 510. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XIVIL or another appropriate structured language in this example. The handling of all requests and responses, as well as the delivery of content between the client device 502 and the application server 508, can be handled by the Web server 506. It should be understood that the Web and application servers are not required and are merely example components, as structured code discussed herein can be executed on any appropriate device or host machine as discussed elsewhere herein.

The data store 510 can include several separate data tables, databases or other data storage mechanisms and media for storing data relating to a particular aspect. For example, the data store illustrated includes mechanisms for storing production data 512 and user information 516, which can be used to serve content for the production side. The data store also is shown to include a mechanism for storing log or session data 514. It should be understood that there can be many other aspects that may need to be stored in the data store, such as page image information and access rights information, which can be stored in any of the above listed mechanisms as appropriate or in additional mechanisms in the data store 510. The data store 510 is operable, through logic associated therewith, to receive instructions from the application server 508 and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device 502. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 5. Thus, the depiction of the system 500 in FIG. 5 should be taken as being illustrative in nature and not limiting to the scope of the disclosure.

Various aspects can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft Sybase®, Amazon® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A computer-implemented method for analyzing transactions, comprising:
receiving with a processor transaction data comprising data reflecting the transfer of an asset from a first entity to a second entity in exchange for a payment from the second entity, the asset represented in a balance ledger associated with the first entity;
receiving with a processor entity description data associated with the first entity and with the second entity;
determining with a processor a tax authority to which tax is due from the first entity as a result of the transaction based at least in part on the transaction data and the entity description data;
determining with a processor the tax liability incurred by the first entity as a result of the transaction based at least in part on the transaction data, the entity description data, and the tax authority;
transferring funds based on the tax liability to a tax liability account associated with the first entity; and
generating a digital tax stamp representing the tax liability of the first entity to evidence that funds have been transferred to a tax liability account associated with the first entity.

2. The computer-implemented method of claim 1, further comprising:
generating tax liability documentation based at least in part on the digital tax stamp; and
sending funds from the tax liability account to the tax authority based on at least in part the digital tax stamp.

3. The computer-implemented method of claim 1, further comprising:
determining with a processor a change in asset value based at least in part on an asset market value data comprising historical asset market value data corresponding to when the first entity acquired the asset and current asset market value data corresponding to when the transaction occurred; and
wherein determining with a processor the tax liability is further based on the change in asset market value.

4. The computer-implemented method of claim 1, further comprising:
sending the digital tax stamp to an input/output ledger.

5. The computer-implemented method of claim 1, further comprising:
sending the digital tax stamp to a balance ledger.

6. The computer-implemented method of claim 1, further comprising:
signing the digital tax stamp with a cryptographic key.

7. The computer-implemented method of claim 1, further comprising:
sharing the input/output ledger with a third entity.

8. The computer-implemented method of claim 1, further comprising:
providing a financial calendar interface, the financial calendar interface having a grid structure wherein each section of the grid corresponds to a unit of time;
presenting in the financial calendar interface a plurality of balance ledger metrics each respectively corresponding to the unit of time in each rectangular section of the grid;
presenting in the financial calendar interface a plurality of input metrics each respectively corresponding to the unit of time in each rectangular section of the grid; and
presenting in the financial calendar interface a plurality of output metrics each respectively corresponding to the unit of time in each rectangular section of the grid.

9. A computer-implemented method for analyzing transactions, comprising:
receiving with a processor transaction data comprising data reflecting the transfer of an asset from a first entity to a second entity in exchange for a payment from the second entity, the asset represented in a balance ledger associated with the first entity;
receiving with a processor entity description data associated with the first entity and with the second entity;
determining with a processor a tax authority to which tax is due from the first entity as a result of the transaction based on the transaction data and the entity description data;
determining with a processor the tax liability incurred by the first entity as a result of the transaction based on the transaction data, the entity description data, and the tax authority;
transferring funds based on the tax liability to the tax authority; and
receiving from the tax authority a digital tax stamp to evidence that the tax liability has been paid.

10. The computer-implemented method of claim 9, wherein the digital tax stamp contains the digital signature of a cryptographic key associated with the tax authority.

11. The computer-implemented method of claim 9, further comprising:
sending the digital tax stamp to an input/output ledger.

12. The computer-implemented method of claim 9, further comprising:
sending the digital tax stamp to a balance ledger.

13. The computer-implemented method of claim 9, further comprising:
signing the digital tax stamp with a cryptographic key.

14. The computer-implemented method of claim 9, further comprising:
sharing the input/output ledger with a third entity.

15. A system comprising:
a processor capable of executing computer files;
a memory comprising processor-executable computer files for performing the steps of:
receiving with a processor transaction data comprising data reflecting the transfer of an asset from a first entity to a second entity in exchange for a payment from the second entity, the asset represented in a balance ledger associated with the first entity;
receiving with a processor entity description data associated with the first entity and with the second entity;
determining with a processor a tax authority to which tax is due from the first entity as a result of the transaction based at least in part on the transaction data and the entity description data;
determining with a processor the tax liability incurred by the first entity as a result of the transaction based at least in part on the transaction data, the entity description data, and the tax authority;
transferring funds based on the tax liability to the tax authority; and
generating a digital tax stamp representing the tax liability of the first entity to evidence that funds have been transferred to the tax authority to account for the tax owed by the first entity.

16. The system of claim 15, wherein the digital tax stamp contains the digital signature of a cryptographic key associated with the tax authority.

17. The system of claim 15, wherein the processor-executable computer files are configured to further perform the step of:
sending the digital tax stamp to an input/output ledger.

18. The system of claim 15, wherein the processor-executable computer files are configured to further perform the step of:
sending the digital tax stamp to a balance ledger.

19. The system of claim 15, wherein the processor-executable computer files are configured to further perform the step of:
signing the digital tax stamp with a cryptographic key.

20. The system of claim 15, wherein the processor-executable computer files are configured to further perform the step of:
determining with a processor a change in asset value based at least in part on an asset market value data comprising historical asset market value data corresponding to when the first entity acquired the asset and current asset market value data corresponding to when the transaction occurred; and
wherein the determining with a processor the tax liability is further based on the change in asset market value.
